(19) United States
(12) Patent Application Publication
(10) Pub. No.: US 2010/0175586 A1
(43) Pub. Date: Jul. 15, 2010

(54) BIODEGRADABLE PLASTIC MATERIAL

(76) Inventor: Madrisano Catinari, Macerata (IT)

Correspondence Address: YOUNG & THOMPSON, 209 Madison Street, Suite 500, Alexandria, VA, 22314, US

(21) Appl. No.: 11/909,516

(22) PCT Filed: Mar. 24, 2005
(86) PCT No.: PCT/IT05/00166

§ 371 Date: Dec. 14, 2007

(51) Int. Cl. C08L 3/00; C08L 89/00; C08L 7/00

(52) U.S. Cl. 106/125.1; 106/162.1; 106/206.1; 523/124

(57) ABSTRACT

A biodegradable plastic plastic material comprising a natural thermoplastic material is described, which, before moulding, is blended with one or more plasticisers.

### FIELD OF THE INVENTION

The present invention refers to a new plastic material, having the same resilient properties as the conventional plastics, but which can be disposed of with low or even no problem.

### BACKGROUND OF THE INVENTION

Disposal of plastic materials, as they become wastes, is a very big problem. In fact, most polymers are not degradable. Their burning leads to highly toxic materials.

An attempt has been made, by recycling plastics during the preparation of other objects. Unfortunately, most plastics cannot be wholly recycled and they can just be loaded in the polymerisation mixture, in a small amount.

Another attempt has been made by synthesising a so called biodegradable plastic, which in fact dissolves in the water. Unfortunately, in this way plastics become pollutant, since it remains dissolved in rivers, lakes, seas and cannot be easily separated therefrom.

A partial solution are plastics synthesised by corn (for instance the plastic sold under the trade name Mater-Bi). However, such materials exhibit the drawback of being stiff and brittle and they cannot be used for a lot of applications, where resilient and softness properties are required.

Object of this invention is to provide a new plastic material, which exhibits resilient properties and which can be biodegraded after compounding.

### SUMMARY OF THE INVENTION

The drawbacks above are brilliantly solved by the present invention, which refers to a biodegradable plastic material comprising a natural thermoplastic material, characterised in that, before moulding, it is blended with one or more recyclable plasticisers.

### BEST WAY OF CARRYING OUT THE INVENTION

According to the present invention, a plastic material is provided, which comprises a natural thermoplastic material, which is blended before moulding with a recyclable plasticiser.

A class of natural thermoplastic materials, which is suitable for this invention is the class comprising thermoplastic materials like natural polymers or polymers from natural substances, hydroxyalkanoates, like polyhydroxy butirrate and its copolymers, polylactic acid, cellulose and starch derivatives, polyglutamic acid, soybean proteins and derivatives, alginates and similar polysaccharides from fungi and bacteria, natural rubber.

Particularly suitable is the thermoplastic material from starch corn sold under the trade name Mater-Bi.

As natural plasticiser, recyclable substances are preferred which can be mixed with the polymer in an optimum way, such as thermoplastic rubbers, which improve mechanic properties like plastic behaviour, elongation ability and glass transition temperature.

Block copolymers styrene-(ethylene-butylene)-styrene and polyolefines are particularly suitable. The material called Laprene® has proven particularly suitable. It provides the inventive plastic material with an optimal strength to ozone, to UV rays and to weather; chemical inertia towards acids, bases, surfactants, polar solvents and aqueous solutions; the possibility to use the moulds at a temperature ranging from −50 to +100° C.; the possibility to obtain moulds having parts with different hardness; easy colourability. Block copolymers styrene-butadiene-styrene plus polyolefines can be added or substitute the copolymers above. Polypropylene or polystyrene can be mentioned as polyolefines contained in the copolymer. The copolymer sold under the trade name of Sofprene-T° is particularly suitable.

Dyes and lubricant can be possibly added to the composition. Preferably, such dyes and lubricants are from natural sources. As for the dyes, biodegradable master-batches can be added, in a concentration of 1 wt % to 5 wt %, for instance 3 wt %

The biodegradable plastic material of the present invention is particularly suitable for every purpose in which a flexible material is required. Particular examples are shoe soles, boots, clogs, slippers of sea, belts, bags, adhesive bands, plasters, bottles and containers, watch straps, book covers, toys for babies, interior decoration objects and similar.

Preferably, the natural thermoplastic material is present in an amount of 50 to 90 wt %, preferably from 50 to 70 wt % and the plasticiser is present in an amount of 10 to 50 wt %, preferably of 30 to 50 wt %. Particularly preferable is a content in natural thermoplastic material of 50 to 60 wt % and of plasticiser of 40 to 50 wt %. The lubricant can be present in an amount of 0 to 5 wt %, preferably of 1 to 3 wt %, most preferably of 2.5 wt %

The plastic material according to the present invention is at least partially biodegradable, has the same plastic features as the conventional plastic material, it is cheap to produce and can be used for a large number of application.

1) A biodegradable plastic material comprising a natural thermoplastic material, characterised in that, before moulding, it is blended with one or more recyclable plasticisers.

2) A biodegradable plastic materials as claimed in claim 1), characterised in that the natural thermoplastic material is chosen in the group consisting of natural polymers or polymers from natural substances.

3) A biodegradable plastic material as claimed in claim 1), characterised in that the natural thermoplastic material is chosen among the hydroxyalkanoates.

4) A biodegradable plastic material as claimed in claim 2), characterised in that the natural thermo-plastic material is chosen from the group comprising poly-hydroxy butirrate and its copolymers, polylactic acid, cellulose and starch derivatives, polyglutamic acid, soybean proteins and derivatives, alginates and similar polysaccharides from fungi and bacteria, natural rubber.

5) A biodegradable material as claimed in claim 1, characterised in that the thermoplastic material is based on corn starch.

6) A biodegradable plastic material as claimed in claim 1, characterised in that the plasticiser is chosen in the group consisting of thermoplastic rubbers.

7) A biodegradable plastic material as claimed in claim 6), characterised in that the said thermoplastic rubber is chosen from the group consisting of block copolymers styrene-(ethylene-butylene)-styrene and polyolefines.

8) A biodegradable plastic material as claimed in claim 6), characterised in that the said thermoplastic rubber is a block copolymer styrene-butadiene-styrene plus a polyolefine.

9) A biodegradable plastic material as claimed in claim 8), characterised in that the said polyolefine is chosen among polypropylene and polystyrene.

10) A biodegradable plastic material as in claim 1, characterised in that the natural thermoplastic material is present in an amount of 50 to 90 wt % and the plasticiser is present in an amount of 10 to 50 wt %.

11) A biodegradable plastic material as claimed in claim 10), characterised in that the content in natural thermoplastic material is 50 to 70 wt % and of plasticiser of 30 to 50 wt %.

12) A biodegradable plastic material as claimed in claim 10), characterised in that the natural thermoplastic material is present in an amount of 50 to 60 wt % and the plasticiser in an amount of 40 to 50 wt %.

13) A biodegradable plastic material as claimed in claim 1, characterised in that it further comprises a lubricant.

14) A biodegradable plastic material as claimed in claim 13), characterised in that the said lubricant has natural origin.

15) A biodegradable plastic material as claimed in claim 13), characterised in that the lubricant content is of 0 to 5 wt %.

16) A biodegradable plastic material as claimed in claim 15), characterised in that the content of lubricant is 1 to 3 wt %.

17) A biodegradable plastic material as claimed in claim 16), characterised in that the lubricant content is 2.5 wt %.

18) A biodegradable plastic material as claimed in claim 1, characterised in that it further comprises a natural dye.

19) A biodegradable plastic material as claimed in claim 18), characterised in that the said dye is a biodegradable master-batch.

20) A biodegradable plastic material as claimed in claim 18), characterised in that the said dye is present in a concentration of 1 to 5 wt %.

21) A biodegradable plastic material as claimed in claim 20), characterised in that the said dye is present in a concentration of 3 wt %.

22) (canceled)
